(19) United States
(12) Patent Application Publication
(10) Pub. No.: US 2007/0036939 A1
(43) Pub. Date: Feb. 15, 2007

(54) Touch fasteners

(76) Inventors: Kristel L. Ferry (Hinton), Methuen, MA (US); John M. Ramos, Suncook, NH (US)

Correspondence Address: FISH & RICHARDSON PC, P.O. BOX 1022, MINNEAPOLIS, MN, 55440-1022, US

(21) Appl. No.: 11/204,560

(22) Filed: Aug. 15, 2005

(51) Int. Cl. B32B 3/06

(52) U.S. Cl. 428/100; 428/99

(57) ABSTRACT

Touch fasteners and methods of making touch fasteners are described. The touch fasteners carry a graphic on the upper surface thereof and can be used, for example in a variety of consumer applications.

### TECHNICAL FIELD

This invention relates to touch fasteners.

### BACKGROUND

Touch fastener products have a wide variety of uses, including many uses in consumer products. In some instances it is desirable for the touch fastener to include a print or a pattern, for example a logo, a trademark, a graphic, etc, which can be used to identify the brand of the product of to otherwise provide decoration of the touch fastener.

### SUMMARY

It has been discovered that in certain instances, fastener products can be produced that include a desired print or graphic on the surface thereof. For example, a print or graphic that is on a film can be adhered onto a touch fastener. The film can be adhered, for example by simultaneously introducing a film into a mold while forming a male fastener component of a touch fastener.

In one aspect, the invention features a method of making a touch fastener having a sheet form base and a plurality of fastener elements having stems extending from the base. The method includes: (a) continuously introducing molten resin to a gap formed along a peripheral surface of a rotating mold roll, such that the resin forms at least a part of the sheet-form base at the peripheral mold roll surface and at least partially fills an array of fixed cavities defined in the rotating mold roll to form the fastener elements in the form of projections; (b) continuously introducing a film into the gap between the mold roll and the molten resin; (c) solidifying the resin; (d) forming engageable heads; and (e) removing the solidified resin from the peripheral surface of the mold roll by pulling the projections from their respective cavities.

Some implementations include one or more of the following features. The heads may be formed by molding the heads on the stems in the cavities. Alternatively, the heads may be formed after removing the resin from the mold roll. The molten resin may pierce the film as it at least partially fills the arrays of fixed cavities. At least a portion of the film may enter into the array of fixed cavities defined in the rotating mold roll. The film may carry a graphic, which in some cases may be substantially transferred onto the upper surface of the sheet form base. The film comprises a resin. The molten resin may be different from or the same as the film resin. The molten resin and the film resin may be in the same chemical family, for instance the molten resin and the film resin may both be polyolefin resins. The softening point of the film may be from about 120° C. to about 160° C. The temperature of the molten resin may be from about 200° C. to about 240° C. The melting point of the film may be approximately equal to the temperature of the molten resin. The film may have a nominal thickness of from about 0.0008″ to about 0.005″. The gap may be defined between the mold roll and a counter-rotating pressure roll, or alternatively between the mold roll and an injection die. In some cases, the cavities form preformed stems and the method further comprising flat-topping the stems to form fastener elements.

In another aspect, the invention features a touch fastener product including a sheet form base, comprising an upper surface and a lower surface, and a plurality of fastener elements extending from the upper surface; and a film adhered to the upper surface of the sheet form base.

The sheet form base and film may be formed of different resins. The resins may be in the same chemical family, e.g., they may both be polyolefins. Alternatively, the sheet form base and film may be formed of the same resin. The film adhered to the upper surface of the sheet form base may also be adhered to at least a portion of the plurality of fastener elements. The male fastener elements may define hooks, palm tree shapes, or mushroom shapes. The fastener elements may have a height of less than about 0.05 inch (1.37 millimeters), e.g., about 0.005 and 0.05 inch (0.127 and 1.27 millimeters). The fastener elements may be arranged with a density of at least about 100 fastener elements per square inch (15.5 hooks per centimeter), e.g., at least about 1000 fastener elements per square inch (155 hooks per centimeter).

In yet another aspect, the invention features a touch fastener product including (a) a sheet form base, comprising an upper surface and a lower surface, and a plurality of fastener elements extending from the upper surface; and (b) a film adhered to the upper surface of the sheet form base, wherein the film carries a graphic that is substantially transferred to the upper face of the sheet form base.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a top view of a touch fastener product carrying a graphic on its upper surface.

FIG. 2 shows schematically an apparatus and process for manufacturing a touch fastener having a film adhered to the upper face of a sheet form base.

FIG. 3 shows schematically an apparatus and process for manufacturing a touch fastener having a film adhered to the upper face of a sheet form base.

FIG. 4 is a side view of a touch fastener having a film adhered to its upper surface.

FIGS. 5 and 6 are side views of alternative embodiments of a touch fastener having a film adhered to its upper surface.

Like reference symbols in the various drawings indicate like elements.

### DETAILED DESCRIPTION

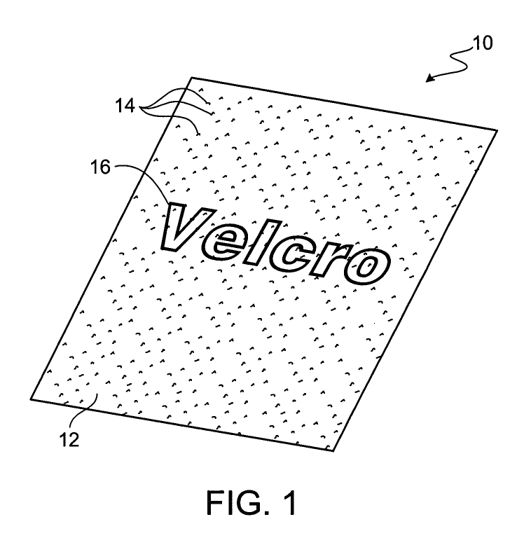

Referring to FIG. 1 a touch fastener 10 includes an upper face 12 having male fastener elements 14 extending therefrom. Adhered to the upper face 12 is a film carrying a graphic 16, which can be readily seen from the upper face 12 of the touch fastener 10.

Although touch fastener 10 has a graphic bearing the Velcro® registered trademark, other graphics can be readily envisioned. For example, in general, any branding graphic can be used, or alternatively a decorative print can be adhered to the upper face of the touch fastener.

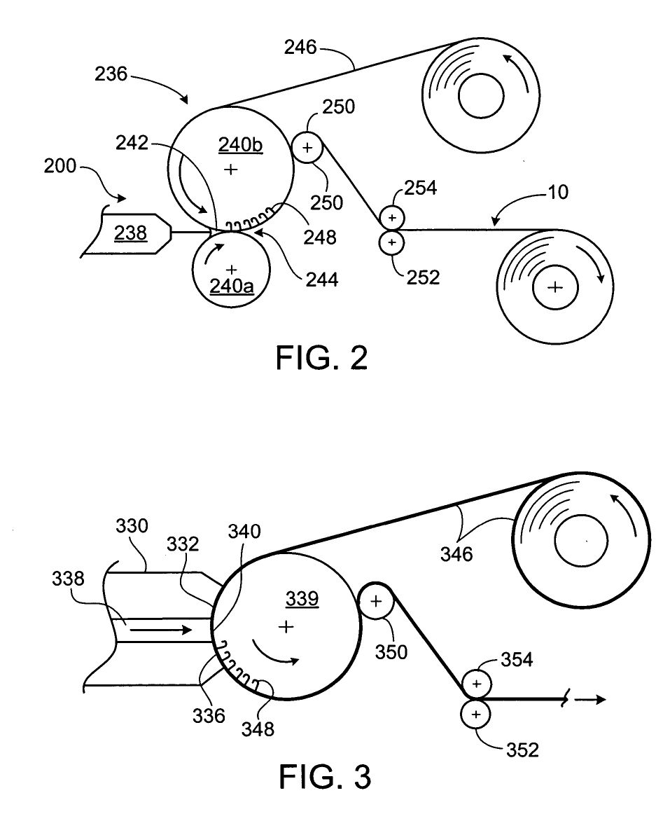

Touch fastener 10 can be manufactured, for example, as illustrated in FIGS. 2 and 3.

FIG. 2 illustrates one method and apparatus for producing the above described touch fastener. The method utilizes the continuous extrusion/roll-forming method for molding fastener elements on an integral, sheet-form base described in detail in U.S. Pat. No. 4,794,028, the disclosure of which is incorporated herein by reference. As shown in FIG. 2, touch fastener 10 is formed by an extrusion apparatus 200 including a molding/calendaring assembly 236. The assembly includes an extrusion head 238, a base roll 240a, and a mold roll 240b. In FIGS. 2 and 3, the relative position and size of the rolls and other components is not to scale.

The extrusion head 238 supplies a continuous sheet of molten resin 242 to a nip 244 formed between the base roll 240a and the mold roll 240b. As molten resin 242 enters nip 244, a sheet of film 246 is fed through the nip 244 between the mold roll 240b and the molten resin 242. Due to pressure applied at the nip by rolls 240a and 240b, molten resin 242 is forced into hook cavities 248, forming the hooks 220. A guide roller 250 is situated diagonally upwardly to assist in the removal of the finished touch fastener 10 from mold roll 240b. A set of upper and lower take-up rollers 252, 254, rotating at a speed slightly higher than the rotating speed of the die wheel 234, are situated forwardly of the guide roller 250.

FIG. 3 shows an alternative process for manufacturing a touch fastener having a film adhered onto the upper face of a sheet-form base. An injection die 330 has an upper half arcuate surface 332 that is substantially equal in curvature to a die wheel 334, and a lower half surface 336 having a curvature that defines a predetermined gap with respect to the curved surface of the die wheel 334. The injection die 330 has a resin extrusion outlet 338, which is situated centrally of the upper and lower surfaces 332, 336 and from which molten resin 340 is extruded in a sheet form under a predetermined pressure.

The structure of the die wheel 334 is substantially identical with the structure disclosed in U.S. Pat. No. 4,775,310, which is incorporated herein by reference in its entirety. Die wheel 334 defines a multiplicity of hook-element-forming cavities 346 with their bases opening to the circumferential surface of the die wheel. The die wheel 334 is driven to rotate in the direction indicated by the arrow in FIG. 3.

A sheet of film 346 is drawn from a roll and introduced between the upper arcuate surface 332 of the injection die 330 and the circumferential surface of the die wheel 334. A guide roller 350 is situated diagonally upwardly, and a set of upper and lower take-up rollers 352, 354 rotating at a speed slightly higher than the rotating speed of the die wheel 334, are situated forwardly of the guide roller 350.

The nature of the finished touch fastener product, and in particular the positioning of the film on the upper face of the touch fastener product, is dependent on a variety of factors. These factors include the melting point of the film, the thickness of the film, the temperature of the molten resin, and the speed of the mold roll. The film will soften (no longer support a useful load) and in some cases will melt, depending on the temperature of the heated rolls and the molten polymer. The behavior of the film can be manipulated by selecting a film having appropriate Vicat softening and melting temperatures. The film may not need to be completely softened or melted, as the pressure of the molten polymer alone will in some cases be adequate to allow the molten polymer to pierce through the film and enter the mold cavity. The thickness of the film is also an important factor. The thicker the film, the harder it will be for the film to be pierced by the molten polymer. The mechanical properties of the film will also affect piercing, with tougher, more elastic materials being more difficult to pierce. The adhesion of the molten polymer to the film will be affected by the chemical compatibility of the materials used, as is well understood in the art.

Another factor that will affect the form of the final product will be the heat exchange between the relatively cool surface of the mold cavity and the film. The rate of cooling will have an effect on the penetration of the film into the cavity, with higher cooling rates tending to decrease the penetration. This is balanced by the heat and pressure the film is exposed to through the calendar rolls and molten polymer. Increased heat and pressure will aid the film penetration. Additionally the operating speed of the mold roll will also influence formation; operating speed may need to be adjusted to allow for complete fill of the hook cavity, as the film will tend to provide a barrier. This can be minimized by adjusting temperature and pressure.

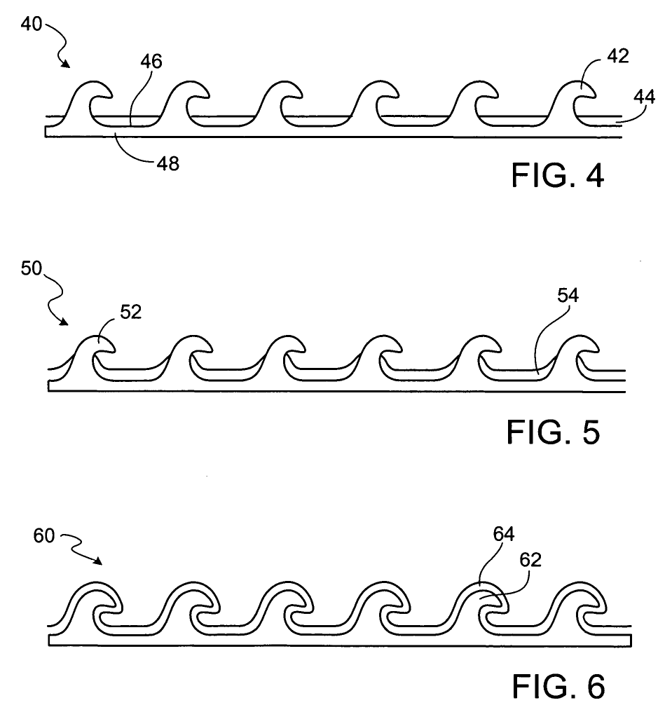

Referring to FIG. 4, touch fastener 40 includes touch fastener elements 42 that are substantially free of film 44. Instead, the film 44 is limited almost entirely td being adhered to the upper face 46 of the sheet form base 48. In some instances, for example, where the film 44 is very thin, e.g., about 0.002 inches thick or thinner, the film 44 can be pierced by the molten resin forming the fastener elements 42 as the pressure is applied and the molten resin enters into the mold cavities in the processes described above. In other instances, for example, where the melting point of the film 44 is significantly higher than the temperature of the molten resin, or the film is relatively thick (e.g., at least about 0.005 inches thick), the molten resin pierces through the film 44 as the resin enters the mold cavities, with little to no physical change (i.e., change from a solid to liquid phase) in the film 44. If the surfaces of two solid bodies are brought into contact, the contact surface resists heat transfer. This behavior is a function of the surface properties, contact force, and any liquid or gaseous media in the contact plane. In this case the contact surface is the film, and in some cases before the film has a chance to melt, it may succumb to the pressure of the molten resin flowing into the cavity and be pierced. This would be especially true for thin films, but is also a reflection of mechanical properties of the film, such as toughness, stiffness, and strength. A tougher, stronger, more elastic material will be harder to pierce. If the film is thicker and tougher, more heat will transfer before the film succumbs to pressure of the molten resin. This could approach the softening temperature of the film, or even the melting temperature. Thicker and tougher films will have more chance to accumulate heat from the molten resin and then melt and soften. This allows greater penetration of the film into the mold cavity. Softening temperatures vary, but may be, for instance, around 140° C. (280° F.). The film is generally at room temperature prior to entering the nip. Once the film is fed into the calendar stack it begins to see heat from the stack itself and ultimately from the molten resin. The film may not have enough time to equilibrate with the molten resin or even reach softening or melting temperatures as it quickly turns through the calendar stack. In this case the film may not bond very strongly to the molten polymer. There may only be enough heat present for a very loose thermal bond. Yet this bond, coupled with the amount of hooks the film is now pierced by, will be sufficient to hold the two layers together.

In general, the film is made of a resin that is compatible with the molten resin that forms the sheet form base. For example, the resin of the film and the molten resin forming the sheet form base can both be members of the same chemical family, such as olefins or acrylates (e.g.—polypropylene film laminated onto polypropylene resin).

Referring to FIG. 5, the touch fastener 50 includes fastener elements 52 that are partially covered with film 54. During the molding process the molten resin pierces through the film 54 when entering into the mold cavities, and while entering the mold cavities, carries a portion of the film 54 into the cavity. For example, as the film 54 becomes thicker, a greater amount of film must be broken through for the molten resin to enter into the mold cavities. In these instances, the film 54, to a varying degree, can be carried into the mold cavities together with the molten resin, thus forming a coating over at least a portion of the fastener element 52. In some instances, where the melting point of the film 54 is relatively close to the temperature of the molten resin, the film 54 becomes soft, approaching a liquid state during the molding process. As the film 54 softens, it becomes easier for the molten resin to carry the film 54 into the hook cavity, thus coating at least a portion of the hook 52 with film 54.

Referring to FIG. 6, touch fastener 60 includes fastener elements 62 where the film 64 entirely surrounds the fastener elements. For example, in instances where the film 64 is sufficiently thick, the molten resin does not actually pierce through the film 64 as it enters into the mold cavity, but instead pushes the film 64 into the mold cavity. Thus the molten resin enters the mold cavity behind the film 64, never actually making contact with the mold surface, and is surrounded by the film 64, which is in contact with the mold surface. In some embodiments, for example, where the melting point of the film 64 is equal to or less than the temperature of the molten resin, the film 64 becomes a liquid as it enters the nip. As the now liquid film 64 and molten resin forming the sheet form base undergo pressure in the nip, the molten resin follows the liquid film 64 into the mold cavity, and thus is encapsulated by the film 64 as it forms the fastener elements.

In general, the film carries a graphic, which is visible and recognizable after undergoing the molding process. In order to maintain the integrity of the graphic, it is preferred that the film is not distorted as it moves through the nip and the molding process. The quality of the image on the touch fastener can vary depending on a number of variables, including, for example, the size and density of the fastener elements and the integrity of the film as it proceeds through the molding operation. Tension on the film will also affect the image quality, as tension will help keep the film from bunching. It is also generally important that the film unwinds freely and at a rate comparable to or equal to the extrusion rate.

Examples of suitable resins that can be used to form the sheet form base and fastener elements include HDPE (high density polyethylene), LLDPE (linear low density polyethylene), polyamides, polyesters, polypropylene, polyethylene, PVC (polyvinyl chloride), ABS (acrylonitrile butadiene styrene), acetals, acrylics, polycarbonate, polystyrene, SAN, polyurethanes, PTFE (polytetrafluoroethylene), EVA (ethylene vinyl acetate), thermoplastic elastomers, thermoplastic olefins, urethanes, PBT (polybutylene terephthalate), copolymer thereof, and other engineering resins.

In general, the film is made from a resin material, for example a resin material that is compatible with the resin material forming the sheet form base and fastening elements. Compatibility between the film resin and the resin forming the sheet form base provides improved adherence of the film to the upper face of the sheet form base. For enhanced compatibility, it may be preferable that the resin of the film be in the same chemical family as the resin forming the sheet form base, and in some cases the film and sheet form base may be formed of the same polymer. In general, the resins listed above may also be used to form the film. In some preferred embodiments, an LLDPE film is adhered (e.g., laminated) onto polypropylene hook tape, or PVC is used in combination with ABS, acrylic, or polystyrene.

Additionally, in some embodiments films can be multilayered and/or multicomponent. For example, a film can have a first layer, in contact with the sheet form base, that is compatible with the resin forming the sheet form base, and a second layer that is compatible with the first layer, but not necessarily compatible with the resin forming the sheet form base.

In general, the thickness of the film is from about 0.0008″ to about 0.005″, for example less than about 0.01″, such as about 0.0018″.

The film melting point and the resin's melting point should generally be in the same range. The film will generally be slow to heat, although the process can be adjusted by varying the temperature, pressure, film thickness, and chemistry and mechanical properties of the film. The resin may be molten at, for example, around 220° C. (430° F.), whereas the film need not reach this temperature or even its softening temperature (e.g., around 140° C. (280° F.)) for the film to interact with the molten resin. The pressure alone could allow the film to be pierced and the cooling molten resin will form a weak thermal bond with the film. In some cases, however, the film will melt or soften, allowing it to penetrate further into the mold cavity.

The touch fasteners described herein can be used with a variety of products, such as consumer products, where it would be desirable to have a decorative or branded fastener. For example, the touch fasteners described herein can be used as fasteners in a diaper where the touch fastener carries a graphic with a familiar story character or the trademark of the diaper maker. The touch fasteners can also be used in most existing applications for hook and loop fasteners, for example straps, seat closures, single patient use devices, diapers, and other fastener products. In all cases, it provides the ability to add text, coding, branding, identification, or design to the front of the hook tape. Films could be used to add desired surface characteristics, such as a soft feel or a texture.

The techniques described herein also allow a hook to be multi-layered, with the layers being formed of different materials.

A number of embodiments of the invention have been described. Nevertheless, it will be understood that various modifications may be made without departing from the spirit and scope of the invention. Accordingly, other embodiments are within the scope of the following claims.

What is claimed is:

1. A method of making a touch fastener having a sheet form base and a plurality of fastener elements having stems extending from the base, the method comprising:
(a) continuously introducing molten resin to a gap formed along a peripheral surface of a rotating mold roll, such that the resin forms at least a part of the sheet-form base at the peripheral mold roll surface and at least partially fills an array of fixed cavities defined in the rotating mold roll to form the fastener elements in the form of projections;
(b) continuously introducing a film into the gap between the mold roll and the molten resin;
(c) solidifying the resin;
(d) forming engageable heads; and
(e) removing the solidified resin from the peripheral surface of the mold roll by pulling the projections from their respective cavities.

2. The method of claim 1 wherein the heads are be formed by molding the heads on the stems in the cavities.

3. The method of claim 1 wherein the heads are formed after removing the resin from the mold roll.

4. The method of claim 1 wherein the molten resin pierces the film as it at least partially fills the arrays of fixed cavities.

5. The method of claim 1 wherein at least a portion of the film enters into the array of fixed cavities defined in the rotating mold roll.

6. The method of claim 1 wherein the film carries a graphic.

7. The method of claim 6 wherein the graphic is substantially transferred onto the upper surface of the sheet form base.

8. The method of claim 1 wherein the film comprises a resin.

9. The method of claim 1 wherein the molten resin is different from the film resin.

10. The method of claim 1 where the film has a nominal thickness of from about 0.0008″ to about 0.005″.

11. The method of claim 1 wherein the gap is defined between the mold roll and a counter-rotating pressure roll.

12. The method of claim 1 wherein the gap is defined between the mold roll and an injection die.

13. The method of claim 3 wherein the cavities form preformed stems and the method further comprising flat-topping the stems to form fastener elements.

14. A touch fastener product including a sheet form base, comprising an upper surface and a lower surface, and a plurality of fastener elements extending from the upper surface; and a film adhered to the upper surface of the sheet form base.

15. The touch fastener of claim 14 wherein the sheet form base and film are formed of different resins.

16. The touch fastener of claim 14 wherein the film adhered to the upper surface of the sheet form base is also adhered to at least a portion of the plurality of fastener elements.

17. The touch fastener of claim 14 wherein the male fastener elements define hooks, palm tree shapes, or mushroom shapes.

18. The touch fastener of claim 14 wherein the fastener elements have a height of less than about 0.05 inch (1.37 millimeters).

19. The touch fastener of claim 14 wherein the fastener elements are arranged with a density of at least about 100 fastener elements per square inch (15.5 hooks per centimeter).

20. A touch fastener product including (a) a sheet form base, comprising an upper surface and a lower surface, and a plurality of fastener elements extending from the upper surface; and (b) a film adhered to the upper surface of the sheet form base, wherein the film carries a graphic that is substantially transferred to the upper face of the sheet form base.
